(19) United States
(12) Patent Application Publication
(10) Pub. No.: US 2018/0014511 A1
(43) Pub. Date: Jan. 18, 2018

(54) ANIMAL RIG

(71) Applicants: Elise Francken, Export, PA (US); Gregory J. Francken, Export, PA (US)

(72) Inventors: Elise Francken, Export, PA (US); Gregory J. Francken, Export, PA (US)

(21) Appl. No.: 15/208,762

(22) Filed: Jul. 13, 2016

(51) Int. Cl. A01K 27/00; A44B 18/00

(52) U.S. Cl. CPC A01K 27/008; A44B 18/0023; A01K 27/001; A01K 27/005

(57) ABSTRACT

An animal rig assembly is provided. The animal rig assembly is structured to be coupled to a use device. The animal rig assembly includes a primary member assembly and an attachment assembly. The primary member assembly includes an elongate body. The primary member body includes an outer surface, an inner surface, a first end, a medial portion, and a second end. The attachment assembly is coupled to the primary member body. The attachment assembly is structured to position the use device on the primary member body inner side. The attachment assembly includes number of enclosed couplings. The number of enclosed couplings includes a first enclosed coupling. The first enclosed coupling is structured to enclose a portion of the use device.

### BACKGROUND OF THE INVENTION

### Field of the Invention

The disclosed and claimed concept relates to an animal rig, e.g., a collar, harness or bridle, for an animal and, more particularly, to a rig including an enclosed coupling that is structured to couple a use device, e.g., a medicated collar, to an inner surface of the animal rig.

### Background Information

Animal rigs, such as collars/harnesses for dogs and cats, and, bridles for farm animals are known. While it is understood that “rigs” is a broader term than collar, most people are accustomed to dog and cat collars and such a collar will be used as an example hereinafter. Such collars were, typically, first used to control and/or restrain the animal or for decoration. Subsequently, collars were adapted for other uses. For example, medicated collars including flea and tick medication designed to kill or discourage pests were invented. Further, strips of similar medicated material were attached to bridles for farm animals. Thus, an animal would typically wear two collars or have a strip of exposed medicated material on a bridle. This is a disadvantage in that the medicated material was exposed. This was both unattractive and allowed the medicated material to come into contact with humans.

One partial solution to this problem was to couple the medicated material to a decorative/control collar. For example, as shown in U.S. Design Pat. Nos. 297,776 and 317,217, lateral loops were added to the inner surface of the decorative/control collar. In this configuration, a strip of medicated material could be coupled to the inner surface of the decorative/control collar. Thus, the medicated material was hidden from view and was less likely to contact a human. These collars, however, also had disadvantages. For example, the medicated material could move axially and fall out of the loops. Conversely, if the medicated material included its own buckle, the medicated material buckle was difficult to access. Further, when a human held the decorative/control collar, which is typically grasped at the buckle, the human would still come into contact with the medicated material.

To partially overcome these disadvantages, the medicated material was coupled to the decorative/control collar, as shown in U.S. Pat. Nos. 4,224,901 and 4,266,511. In these configurations, the medicated material was hidden from view and was less likely to move axially, but was not absolutely restrained. Also, as before, when a human held the decorative/control collar the human would still come into contact with the medicated material. Further, the slip resistant couplings were more difficult to use. This discouraged the pet owners from utilizing the collars. Further, the coupling was not adjustable in length. That is, for example, a growing puppy had a neck with a smaller circumference. The strip of medicated material was typically cut to this smaller size. Although the strip of medicated material was usually effective for only about six months, a puppy could grow a considerable amount during this time. Thus, as the puppy grew and its neck grew larger, the strip of medicated material was now smaller than the collar and could become disengaged from the lateral loops. Alternatively, if the strip of medicated material was not cut, the medicated material extended beyond the collar and was exposed.

Further, new technology has increased the number of use devices that can be coupled to a collar. For example, “use devices” as used herein, include, but are not limited to, a Global Positioning System (GPS) tag, therapy devices (e.g., a vibrating band to calm pets during storms), control devices (e.g., an electrical shock device), and/or devices that are not strips of material (e.g., a number of health monitoring units). These devices are also unsightly and may be harmful to humans. Thus, these devices are also advantageously hidden behind a decorative/control collar.

Thus, the stated problems with the known art include difficulty coupling the use device to the rig, axial movement of the use device once coupled to the rig, couplings that do not adapt to the length of the rig, exposure to the use device when the user handles the rig at the buckle, and the inability to be coupled to other use devices. There is, therefore, a need to improve rigs so as to more easily couple a use device to the rig. Further, there is a need for a coupling assembly that substantially resists axial movement of the use device. Further, there is a need for a coupling that adapts to the length of the use device and the rig. Further, there is a need for a coupling that protects a human who handles the rig at the buckle, i.e., at a primary coupling assembly. Further, there is a need for the coupling assembly to be able to couple other use devices to the rig.

### SUMMARY OF THE INVENTION

These needs, and others, are met by at least one embodiment of this invention which provides an animal rig assembly structured to be coupled to a use device wherein the animal rig assembly includes a primary member assembly and an attachment assembly. The primary member assembly includes an elongated body. The primary member body includes an outer surface, an inner surface, a first end, a medial portion, and a second end. The attachment assembly is coupled to the primary member body. The attachment assembly is structured to position the use device on the primary member body inner side. The attachment assembly includes a number of enclosed couplings. The number of enclosed couplings includes a first enclosed coupling. The first enclosed coupling is structured to enclose a portion of the use device.

The configuration of the animal rig assembly solves the problems stated above. For example, the strip of medicated material remains coupled to the animal rig assembly and cannot shift axially relative thereto. Further, the enclosed couplings enclose the medicated material so that when a user manipulates a buckle on the animal rig, the user is shielded from the medicated material. Further, as the size of the animal rig is adjusted, the medicated material remains coupled to at least one enclosed coupling.

### BRIEF DESCRIPTION OF THE DRAWINGS

A full understanding of the invention can be gained from the following description of the preferred embodiments when read in conjunction with the accompanying drawings in which:

FIG. 1 is a front view of an animal rig in the form of a collar with end pockets.

FIG. 2 is a back view of an animal rig in the form of a collar with end pockets.

FIG. 3 is an isometric view of an animal rig in the form of a collar with compartments.

FIG. 4 is a detail isometric view of a support member coupled to a collar.

### DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept unless otherwise noted.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled,” “temporarily coupled,” or “selectively coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening is made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the statement that two or more parts or components “engage” one another shall mean that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position. Further, as used herein, “directly engage” means that the identified elements directly contact each other.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, the word “unitary” means a component that is created as a single piece or unit. That is, a component that includes pieces that are created separately and then coupled together as a unit is not a “unitary” component or body.

As used herein, a “unitary coupling” or “unitary coupling component” is a coupling component that is unitary with other portions of a body wherein the other portions of the body are not part of the coupling. For example, a construct such as a threaded hook includes a hook portion that is unitary with a threaded portion. The threaded portion of the threaded hook is a “unitary coupling.” Conversely, a coupling assembly such as a snap, i.e., a socket and plug coupling, wherein the coupling components are attached to another construct, e.g., fabric, is not a “unitary coupling.”

As used herein, the term “number” shall mean one or an integer greater than one (i.e., a plurality).

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately” as would be understood by one of ordinary skill in the art.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, an “animal” includes all mammals, birds, reptiles, amphibians and excludes insects, arachnids, fish and underwater creatures other than mammals, birds, reptiles and amphibians.

As used herein, an “animal rig assembly” is a construct structured to be directly coupled to an animal. That is, the “animal rig assembly” contacts the animal that is wearing the “animal rig assembly.” “Animal rig assemblies” include, but are not limited to, collars, harnesses, bridles, yokes and bracelets. Elements that are coupled to an “animal rig assembly” but which do not substantially contact the animal, such as, but not limited to a leash, are not “animal rig assemblies.”

As used herein, an “enclosed coupling” is a coupling component structured to substantially enclose the corresponding coupling component. For example, a closed bore into which a fastener is threaded, and wherein the threaded portion is longer than the head of the fastener, is an “enclosed coupling.” Conversely, a nut for a bolt is not an “enclosed coupling” because both the head of the bolt and the distal end of the bolt are exposed. Further, a coupling component that leaves two or more sides of a corresponding generally planar coupling component exposed is not an “enclosed coupling.” For example, a tab-and-slot coupling assembly, wherein the construct defining the slot does not enclose the tab, is not an “enclosed coupling” in that when the tab is inserted through the slot, the tab is substantially exposed on the back side of the construct defining the slot. Further, a simple loop is not an “enclosed coupling.”

As used herein, an “end enclosure coupling” is a coupling component structured to substantially enclose the corresponding coupling component and wherein the corresponding coupling component is a unitary coupling. For example, a closed bore that corresponds to the threaded portion of a threaded hook is an “end enclosure coupling.” Further, an “end pocket,” as defined below, is an “end enclosure coupling.” Conversely, a coupling wherein the end of the corresponding coupling component is exposed is not an “end enclosure coupling.”

As used herein, an “end pocket” is an enclosure having an opening on one side or over a limited length. For example, a square “end pocket” is enclosed on three sides and open on one side, or, a circular “end pocket” has an opening that extends over an arc of less than about 90 degrees. Further, as used herein an “end pocket” is disposed on an elongated construct wherein the elongated construct has a first end, a second end and a medial portion, and, wherein the “end pocket” opening is disposed adjacent, and facing, i.e., to be toward, the elongated member medial portion. Further, when an elongated construct includes an elongated member that is folded over itself, the “first end” and “second end,” as used herein, are the portions of the elongated member disposed at the distal limits of the folded construct. Further, in a construct including an elongated member that is folded over itself, the portions of the construct that define the tips of the folded member, i.e., where the matter forming the elongated member ends, are, as use herein, the “first terminal end” and the “second terminal end.”

As defined above, a “rig” includes various devices such as a harness and bridle. Most users, however, are accustomed to a collar for a dog or a cat. As such, a collar will be used as an example. It is understood that the disclosure below is applicable to all types of rigs.

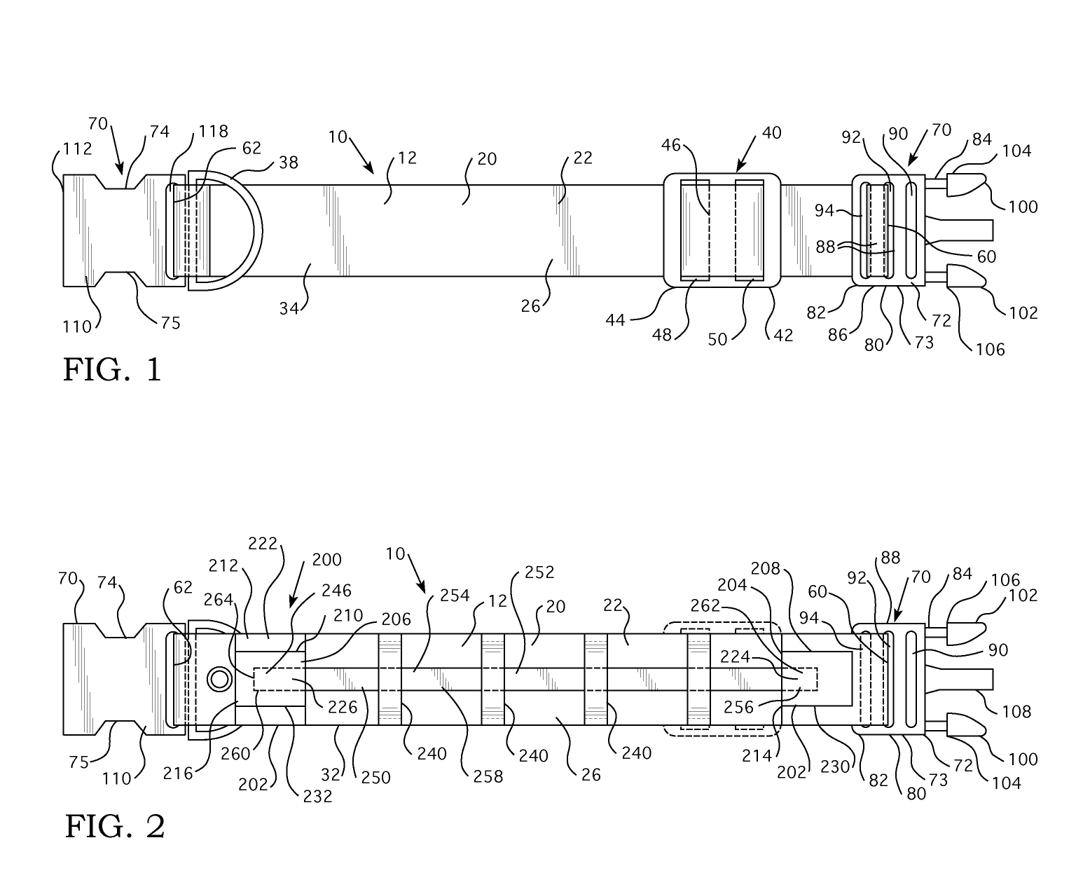

As shown in FIG. 1, an animal rig assembly 10 which, in an exemplary embodiment is in the form of a collar 12, includes a primary member assembly 20, an attachment assembly 200 and a use device 250. The primary member assembly 20 includes an elongated body 22. In an exemplary embodiment, the primary member assembly body 22 is made from a flexible material such as, but not limited to, leather, fabric, or a flexible plastic. The primary member assembly body 22 includes a first terminal end 24, a medial portion 26, and a second terminal end 28. As is known, the primary member assembly body first terminal end 24 is, in an exemplary embodiment, folded over the primary member assembly body medial portion 26 to form a loop 30. The loop 30 includes a number of lateral (i.e., generally perpendicular to the longitudinal axis of primary member assembly body 22) dividers, as shown stitching, which divides the loop 30 into a number of portions. In an exemplary embodiment, not shown, the primary member assembly body second terminal end 28 is also folded over the primary member assembly body medial portion 26 to form a loop 30. In another embodiment, not shown, the primary member assembly body second terminal end 28 is folded over itself so as to be too thick to pass through a length adjustment device 40, discussed below. Further, the primary member assembly 20 includes, in an exemplary embodiment, a D-ring 38 to which a leash, tags, and other constructs may be coupled.

As shown, the animal rig assembly 10 also includes a length adjustment device 40. As is known, the length adjustment device 40 includes a body 42 forming a generally rectangular perimeter 44 with a lateral divider 46. Thus, the length adjustment device body 42 defines two parallel passages 48, 50. The primary member assembly body second terminal end 28 is looped about the length adjustment device body lateral divider 46. The primary member assembly body medial portion 26 is further looped to a buckle, as described below, and passed through the length adjustment device body passages 48, 50. In this configuration, the length of the animal rig assembly 10 is adjustable. That is, the length of the animal rig assembly 10 is not defined by the axial length between the primary member assembly body first terminal end 24 and the primary member assembly body second terminal end 28. Instead, the “ends” of the primary member assembly body 22, and therefore the ends of the animal rig assembly 10, are defined by the loops 30. That is, the primary member assembly body 22 includes a first end 60 and a second end 62. Thus, the length adjustment device 40 is to alter the length of the primary member assembly body 22 between a first length and a second length.

In an exemplary embodiment, the primary member assembly 20 also includes a primary coupling assembly 70. That is, in an embodiment wherein the animal rig assembly 10 is a collar, or other construct structured to encircle a portion of an animal, the primary coupling assembly 70 is structured to couple the two ends of the primary member assembly body 22. In an exemplary embodiment, the primary coupling assembly 70 is a coupling typically identified as a parachute buckle and/or a backpack clip. That is, the primary coupling assembly 70 includes a first primary coupling component 72 and second primary coupling component 74. The first primary coupling component 72, which is also identified herein as a “parachute buckle clip” 73, includes a body 80 having a base portion 82 and a flexure portion 84. In an exemplary embodiment, the first primary coupling component body base portion 82 includes a generally rectangular perimeter 86 with a number of lateral dividers 88. As shown, the first primary coupling component body base portion 82 includes two generally lateral dividers 88 so that the first primary coupling component body base portion perimeter 86 defines three passages 90, 92, 94. In an exemplary embodiment, the primary member assembly body 22 extends through the two first primary coupling component body base portion perimeter passages 92, 94 that are distal to the first primary coupling component body flexure portion 84. As is known, the primary member assembly body 22 is movable through the first primary coupling component body base portion perimeter passages 92, 94 so as to adjust the length of the primary member assembly body 22 from the primary member assembly body first end 60 to the primary member assembly body second end 62.

The first primary coupling component body flexure portion 84 includes two elongated members 100, 102 that extend away from the first primary coupling component body base portion 82 and which are flexible relative thereto. As is known, the first primary coupling component body flexure portion members 100, 102 include latches 104, 106 near their distal tips. As shown, the first primary coupling component body flexure portion 84 includes a third elongated member 108 disposed between the first primary coupling component body flexure portion members 100, 102.

The second primary coupling component 74, which is also identified herein as a “parachute buckle socket” 75, includes an elongated body 110 defining a longitudinal passage 112, two lateral openings 114, 116, and a lateral passage 118. As is known, the second primary coupling component body passage 112 is sized to generally correspond to, and extend about, the first primary coupling component body flexure portion 84. The second primary coupling component body lateral openings 114, 116 define latch surfaces 120, 122. Use of the primary coupling assembly 70 is well known and will not be described herein.

In an exemplary embodiment, the primary member assembly 20 includes a secondary coupling assembly 130. In an embodiment wherein the first enclosed coupling 204, discussed below, is not directly coupled, fixed, or unitary with the primary member assembly body 22 or the first primary coupling component 72, as discussed below, the secondary coupling assembly 130 is structured to couple the first enclosed coupling 204 to the primary member assembly body 22. In an exemplary embodiment, the primary member assembly 20 includes a support member 140. As shown, the support member 140 is a relatively short body 142 of a flexible material such as, but not limited to, the same material as the primary member assembly body 22, and which has a first terminal end 144 and a second terminal end 146. The support member body 142 is thicker at one end. For example, the support member body 142 is folded over itself at the first terminal end 144 hereby making that end thicker.

The secondary coupling assembly 130 includes a secondary coupling first component 132 and a secondary coupling second component 134. The secondary coupling second component 134 is discussed below. The secondary coupling first component 132 is coupled, directly coupled, or fixed to the support member body second terminal end 146. For example, in one embodiment, not shown, the secondary coupling assembly 130 is a snap having a plug (secondary coupling first component) and a socket (secondary coupling second component). In an exemplary embodiment, the secondary coupling assembly 130 is a hook-and-loop coupling and the secondary coupling first component 132 is a patch of hook material. Assembly of this embodiment of the secondary coupling assembly 130 is discussed below.

In another exemplary embodiment, the secondary coupling assembly 130 is also a hook-and-loop coupling and the secondary coupling first component 132 is coupled, directly coupled, fixed, or unitary with the primary member assembly body 22. That is, the secondary coupling first component 132 is disposed on the primary member assembly body 22 at the primary member assembly body first end 60 and generally on the primary member assembly body inner surface 32, described below. For example, the secondary coupling first component 132 is, in an exemplary embodiment, an elongated patch of hook material disposed on the primary member assembly body 22 at the primary member assembly body first end 60 and generally on the primary member assembly body inner surface 32.

In another exemplary embodiment, the secondary coupling assembly 130 is coupled, directly coupled, fixed to, or unitary with, the first primary coupling component 72. For example, the first primary coupling component 72, such as a parachute buckle and/or a backpack clip, includes the secondary coupling first component 132. That is, for example, when the secondary coupling assembly 130 is a hook-and-loop coupling, the first primary coupling component 72 defines a patch of hook material, or, a patch of hook material is coupled to the first primary coupling component 72.

The attachment assembly 200 is structured to position the use device 250 on the primary member body inner surface 32, discussed below. The attachment assembly 200 is coupled, directly coupled, or fixed to, or unitary with, the primary member assembly body 22. In an exemplary embodiment, the attachment assembly 200 includes a number of enclosed couplings 202. For example, when the use device 250 includes an elongated body 254, discussed below, the attachment assembly 200 includes a first enclosed coupling 204 and a second enclosed coupling 206. In an exemplary embodiment, the first enclosed coupling 204 and the second enclosed coupling 206 are each an end enclosure coupling 208, 210, respectively. Further, in another exemplary embodiment, the first enclosed coupling 204 and the second enclosed coupling 206 are each an end pocket 214, 216, respectively. Each enclosed coupling 204, 206 is structured to enclose a portion of the use device 250.

In an exemplary embodiment, each end pocket 214, 216 includes a base member 220, 222, respectively, and a cover member 224, 226, respectively. Each base member 220, 222, as shown, is a generally planar fabric member. For example, the first enclosed coupling 204 has an end pocket 214 (hereinafter “first end pocket” 214) and includes the support member body second terminal end 146. That is, the support member body second terminal end 146 defines the first end pocket base member 220 and/or is unitary therewith. Similarly, the second enclosed coupling 206 has an end pocket 216 (hereinafter “second end pocket” 216) and includes the primary member assembly body second terminal end 28. That is, as shown on FIG. 2, the primary member assembly body second terminal end 28 defines the second end pocket base member 222 and/or is unitary therewith.

In an exemplary embodiment, each of the first end pocket cover member 224 and the second end pocket cover member 226 are generally rectangular members 230, 232 made from a flexible and breathable material. Each of the first end pocket cover member 224 and the second end pocket cover member 226 are coupled, directly coupled, or fixed to, or unitary with, the first end pocket base member 220 and second end pocket base member 222, respectively. That is, the rectangular members 230, 232 are coupled along three of their four edges wherein the assembly of the base members 220, 222 and the cover members 224, 226 form an “end pocket” as defined above. It is noted that the uncoupled edge of the rectangular members 230, 232 are the edges that face the primary member assembly body medial portion 26. In this configuration, the first and second end pockets 214, 216 each define an enclosed space.

In an exemplary embodiment, the first end pocket 214 is coupled, directly coupled, or fixed to a secondary coupling second component 134. For example, when the secondary coupling assembly 130 is a hook-and-loop coupling, the secondary coupling second component 134 is a patch of loop material. The secondary coupling second component 134 is coupled, directly coupled, or fixed to the first end pocket base member 220 on the side opposite the first end pocket cover member 224.

The attachment assembly 200, in an exemplary embodiment, further includes a number of lateral loops 240. The attachment assembly lateral loops 240 are disposed on the primary member assembly body medial portion 26 and on the primary member assembly body inner surface 32, described below. In an exemplary embodiment, the attachment assembly lateral loops 240 are made from a resilient material such as, but not limited to, elastic.

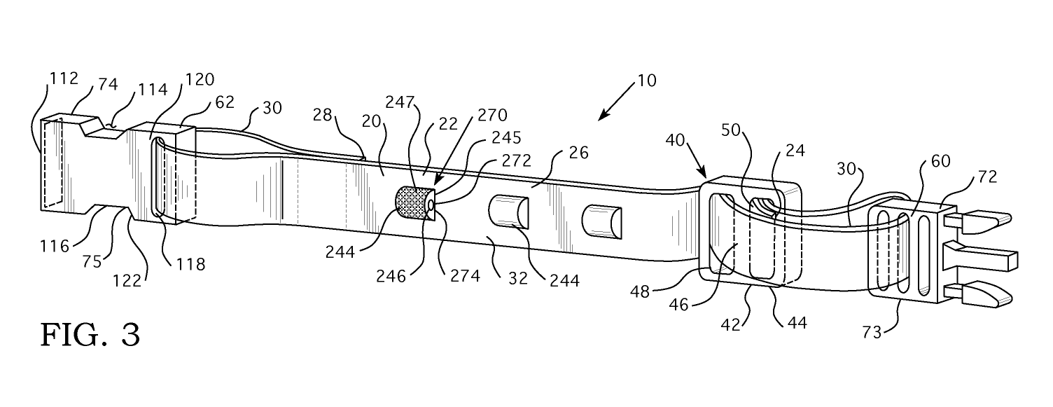

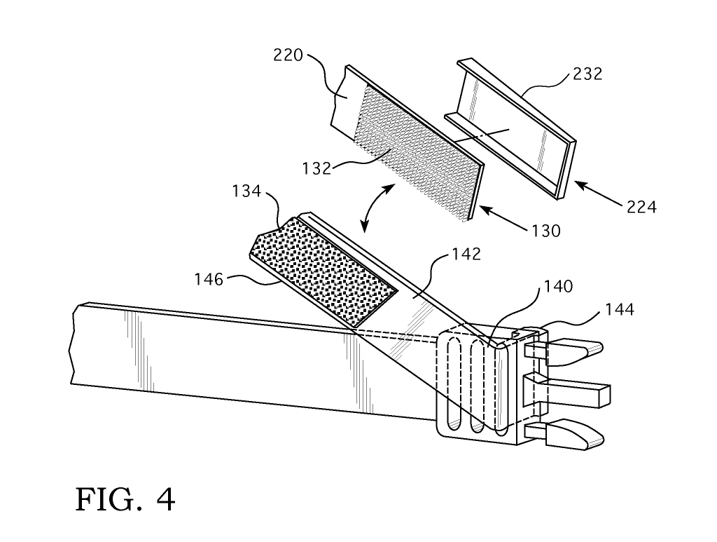

In another exemplary embodiment, the use device 250 includes a number of units 270, described below. To accommodate a use device 250 in this configuration, the attachment assembly 200 includes a number of compartments 244. As used herein, a “compartment” is an “end pocket” that is further structured to enclose all of a use device unit 270. That is, in this embodiment, all of a use device body 245 is also a unitary coupling 246. In this embodiment, each compartment 244 includes a porous surface 247. The porous surface 247 is structured to allow medication to pass therethrough. Further, each compartment 244 is sized to generally correspond to one use device unit 270. In this embodiment, each of a plurality of use devices 250, i.e., a plurality of use devices units 270, are substantially disposed within an associated enclosed coupling 202. As used herein, “substantially disposed within” means most of a construct is disposed with an enclosed space. Thus, the attachment assembly 200 solves the problem of coupling other use devices 250 to the rig assembly 10. As shown in FIG. 3, each compartment 244 is disposed on the primary member assembly body outer surface 34, i.e. the surface not disposed against the animal, as discussed below. In an alternate embodiment, not shown, each compartment 244 is disposed on the primary member assembly body inner surface 32 or both, i.e. at least one of, the primary member assembly body outer surface 34 and the the primary member assembly body inner surface 32.

The use device 250 can be any of the various devices as defined above. In an exemplary embodiment, the use device 250 is a medicated collar 252. The medicated collar 252 includes an elongated body 254 having a first terminal end 256, a medial portion 258, and a second terminal end 260. The use device body first terminal end 256 and use device body second terminal end 260 are, in an exemplary embodiment, unitary couplings 262, 264, respectively. That is, as described below, the use device body first terminal end 256 and use device body second terminal end 260 are structured to be disposed within, and thereby coupled to, the first and second end pockets 214, 216, as described below.

In another embodiment, the use device 250 includes a number, and as shown a plurality, of units 270. As shown, the units 250 each have a relatively small body 272 and each unit 270 fits within a pocket 214, 216. Thus, in this embodiment, the use device unit body 272 is coextensive with a unit coupling component 274. That is, the use device unit body 272 is also the unit coupling component 274.

In an exemplary embodiment, wherein the animal rig assembly 10 is a collar 12 and the use device 250 is a medicated collar 252, the animal rig assembly 10 is assembled as follows. The primary member assembly body 22 is initially in an unfolded configuration. The length adjustment device 40 is movably coupled to the primary member assembly body 22 by passing the primary member assembly body 22 through the length adjustment device body parallel passages 48, 50. The primary member assembly body first terminal end 24 is then movably coupled to the first primary coupling component 72. That is, the primary member assembly body first terminal end 24 is passed through the first primary coupling component body base portion perimeter passages 92, 94 that are distal to the first primary coupling component body flexure portion 84. Further, the primary member assembly body first terminal end 24 is also movably coupled to the primary member assembly body 22 by passing the primary member assembly body first terminal end 24 through the length adjustment device body parallel passages 48, 50. When the primary member assembly body 22 is disposed in this configuration, the primary member assembly body first terminal end 24 and a portion of the primary member assembly body medial portion 26 form a loop 30. While preventing the primary member assembly body 22 from being decoupled, i.e., pulled through, the first primary coupling component 72 and the length adjustment device 40, the first primary coupling component 72 is pulled so as to be spaced from the length adjustment device 40. In this configuration, the first primary coupling component 72 is disposed at the primary member assembly body first end 60.

The primary member assembly body second terminal end 28 is passed through the second primary coupling component lateral passage 118. The primary member assembly body second terminal end 28 is also passed through a D-ring 38. The primary member assembly body second terminal end 28 is then folded over the primary member assembly body medial portion 26 and coupled, directly coupled, or fixed thereto. For example, the primary member assembly body second terminal end 28 is sewn to the primary member assembly body medial portion 26. In this configuration, the second primary coupling component 74 is disposed at the primary member assembly body second end 62.

The support member 140 is then coupled to the first primary coupling component 72. That is, the support member second terminal end 146 is passed through the unused first primary coupling component body base portion perimeter passage 94. Thus, the support member second terminal end 146 is also disposed at the primary member assembly body first end 60.

As noted above, the secondary coupling second component 134 is coupled, directly coupled, or fixed to the first end pocket 214 and the secondary coupling first component 132 is coupled, directly coupled, or fixed to the support member body second terminal end 146. Accordingly, the first end pocket 214 is coupled to the support member second terminal end 146. In this configuration, the first end pocket 214 (which, in this embodiment, is also the first enclosed coupling 204 as well as the first end enclosure coupling 208) is disposed at the primary member assembly body first end 60.

The second end pocket 216 (which, in this embodiment, is also the second enclosed coupling 206 as well as the second end enclosure coupling 210) is disposed at the primary member assembly body second end 62. As noted above, the primary member assembly body second terminal end 28 is, in an exemplary embodiment, the second end pocket base member 222. Thus, the second end pocket 216 is completed by coupling, directly coupling, or fixing the second end pocket cover member 226 to the primary member assembly body second end 62. As noted above, the open side of the first and second end pockets 214, 216 opens toward the primary member assembly body medial portion 26.

At this point, it is noted that the primary member assembly body 22 will be wrapped around an animal's neck. That is, the first primary coupling component 72 and second primary coupling component 74 will be coupled so that the primary member assembly body 22 forms a circle. In this configuration, the primary member assembly body 22 has an inner surface 32 and an outer surface 34. The primary member assembly body 22 is configured so that the first and second end pockets 214, 216, as well as the attachment assembly lateral loops 240, are disposed on the primary member assembly body inner surface 32.

Before wrapping the primary member assembly body 22 about an animal's neck, however, the use device 250 is removably coupled to the attachment assembly 200. That is, in this embodiment, the use device 250 is a medicated collar 252 that includes an elongated body 254 wherein the use device body first terminal end 256 and use device body second terminal end 260 are unitary couplings 262, 264. The use device first terminal end unitary coupling 262 is disposed in the first end pocket 214. The use device body 254 is passed through the attachment assembly lateral loops 240. The use device second terminal end unitary coupling 264 is disposed in the second end pocket 216. In this configuration, the animal rig assembly 10 solves the problem of easily coupling a use device 250 to the rig assembly 10. Further, in this configuration, the first enclosed coupling 204 is an end enclosure coupling 208, and, the second enclosed coupling 206 is structured to be directly coupled to a use device unitary coupling 262. In this configuration, the use device body 254 cannot extend, or shift, beyond the first and second end pockets 214, 216. Thus, the rig assembly 10 solves the problem of resisting axial movement of the use device 250. Further, the enclosed couplings 204, 206 do not extend beyond either of the primary member assembly body first end 60 or the primary member assembly body second end 62. Further, the use device 250, and in this example a medicated collar 252, positions the medicated collar body first terminal end 256 and a second terminal end 260 within an enclosed coupling 202. The enclosed couplings 202 are disposed adjacent to the first primary coupling component 72 and second primary coupling component 74. Thus, the attachment assembly 200 protects a human who handles the rig assembly 10 at the buckle, i.e., at the primary coupling assembly 70.

As noted above, the length adjustment device 40 is structured to alter the length of the primary member assembly body 22 between a first length and a second length. In the configuration disclosed above, the first end pocket 214 moves along with the first primary coupling component 72. Further, the first primary coupling component 72 is movable along the primary member assembly body 22 so that it is always disposed at the primary member assembly body first end 60. Accordingly, the first end pocket 214 is always disposed adjacent the primary member assembly body first end 60. Similarly, in the configuration disclosed above, the second end pocket 216 is always disposed adjacent the primary member assembly body second end 62. Stated alternately, the first enclosed coupling 204 is disposed adjacent the primary member assembly body first end 60 when the primary member assembly body 22 is at the first length and when the primary member assembly body 22 is at the second length, and, wherein the second enclosed coupling 206 is disposed adjacent the primary member assembly body second end 62 when the primary member assembly body 22 is at the first length and when the primary member assembly body 22 is at the second length. Thus, the attachment assembly 200 solves the problem of coupling that adapts to the length of the use device 250 and the rig assembly 10.

Further, in an embodiment where there are multiple use devices 250, e.g., a medicated collar 252 and a small GPS device (not shown), both use devices may utilize the attachment assembly 200. In this embodiment, each use device 250 is disposed at least partially within the first enclosed coupling 204. As used herein, “at least partially within” means all or part of a construct is disposed within an enclosed space. Thus, for example, all of the GPS device is disposed within the first enclosed coupling 204 while only the medicated collar first terminal end 256 is disposed within the first enclosed coupling 204.

It is noted in an alternate embodiment, for example when there is no support member 140 and the first enclosed coupling 204 is directly coupled, via the secondary coupling assembly 130, to the primary member assembly body 22, the first enclosed coupling 204 is movable. That is, in an embodiment wherein the primary member assembly body 22 includes a loop coupling material on the inner surface and the first enclosed coupling 204 is fixed to a patch of hook material, a user can move the position of the first enclosed coupling 204 on the primary member assembly body 22 so that the first enclosed coupling 204 is at the primary member assembly body first end 60. When the attachment assembly 200 is structured to perform this movement, the first enclosed coupling 204 is repositionable as the primary member assembly body 22 is reconfigured between a first and second length. Stated alternately, in an exemplary embodiment, the primary member assembly 20 includes a secondary coupling first component 132, and, the primary member assembly secondary coupling first component 132 is disposed at the primary member assembly body first end 60. Further, the first enclosed coupling 204 includes a secondary coupling second component 134. The first enclosed coupling secondary coupling second component 134 is removably coupled to a primary member assembly secondary coupling second component (not shown). Thus, the first enclosed coupling 204 can be repositioned on the primary member assembly body 22 so that the first enclosed coupling 204 is at the primary member assembly body first end 60.

In an alternate embodiment, the first enclosed coupling 204 and the second enclosed coupling 206 are disposed on the first primary coupling component 72 and the second primary coupling component 74. For example, the parachute buckle components, described above, each define an end pocket 214, 216. Further, as noted above, the first primary coupling component 72 and the second primary coupling component 74 are disposed at the primary member assembly body first end 60 and at the primary member assembly body second end 62, respectively. Thus, the first end pocket 214 is disposed at the primary member assembly body first end 60 and the second end pocket 216 is disposed at the primary member assembly body second end 62. Moreover, the end pockets 214, 216 move with the first primary coupling component 72 and the second primary coupling component 74.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. An animal rig assembly structured to be coupled to a use device wherein said animal rig assembly comprises:
a primary member assembly including an elongate body, said primary member body including an outer surface, an inner surface, a first end, a medial portion, and a second end;
an attachment assembly coupled to said primary member body;
said attachment assembly structured to position said use device on said primary member body inner surface;
said attachment assembly includes number of enclosed couplings;
said number of enclosed couplings includes a first enclosed coupling; and
said first enclosed coupling structured to enclose a portion of said use device.

2. The animal rig assembly of claim 1 wherein:
said first enclosed coupling is an end enclosure coupling; and
said first enclosed coupling is structured to be directly coupled to a use device unitary coupling.

3. The animal rig assembly of claim 1 wherein:
said primary member assembly includes a length adjustment device, said length adjustment device structured to alter the length of said primary member assembly body between a first length and a second length;
said number of enclosed couplings includes a second enclosed coupling;
wherein said first enclosed coupling is disposed adjacent said primary member assembly body first end when said primary member assembly body is at said first length and when said primary member assembly body is at said second length; and
wherein said second enclosed coupling is disposed adjacent said primary member assembly body second end when said primary member assembly body is at said first length and when said primary member assembly body is at said second length.

4. The animal rig assembly of claim 3 wherein:
said primary member assembly includes a secondary coupling first component;
said primary member assembly secondary coupling first component disposed at said primary member assembly body first end;
said first enclosed coupling includes a secondary coupling second component; and
said first enclosed coupling secondary coupling second component is removably coupled to said primary member assembly secondary coupling first component.

5. The animal rig assembly of claim 4 wherein:
said primary member assembly body secondary coupling first component is a hook-and-loop coupling; and
said secondary coupling second component is a hook-and-loop coupling.

6. The animal rig assembly of claim 5 wherein said use device includes an elongated body having a first end, a medial portion, and a second end, said use device body first end including a unitary coupling, said use device body second end including a unitary coupling, and wherein:
said first enclosed coupling is an end pocket; and
said second enclosed coupling is an end pocket.

7. The animal rig assembly of claim 6 wherein:
said primary member assembly includes a first primary coupling component and a second primary coupling component;
said primary member assembly first primary coupling component disposed at said primary member assembly body first end; and
said primary member assembly second primary coupling component disposed at said primary member assembly body second end.

8. The animal rig assembly of claim 7 wherein:
said attachment assembly includes a number of lateral loops; and
each said loop disposed on said primary member assembly body inner surface.

9. The animal rig assembly of claim 3 wherein:
said primary member assembly first coupling component includes said first end pocket; and
said primary member assembly second primary coupling component includes said second end pocket.

10. The animal rig assembly of claim 2 wherein:
said first enclosed coupling is disposed at said primary member assembly body first end; and
said second enclosed coupling is disposed at said primary member assembly body second end.

11. The animal rig assembly of claim 10 wherein said use device includes an elongated body having a first end, a medial portion, and a second end, said use device body first end including a unitary coupling, said use device body second end including a unitary coupling, and wherein:
said primary member assembly includes a first primary coupling component;
said primary member assembly includes a second primary coupling component;
said first enclosed coupling disposed on said primary member assembly body first primary coupling; and
said second enclosed coupling disposed on said primary member assembly body second primary coupling component.

12. The animal rig assembly of claim 11 wherein:
said first primary coupling component is a parachute buckle clip;
said second primary coupling component is a parachute buckle socket;
said first enclosed coupling is an end pocket; and
said second enclosed coupling is an end pocket.

13. The animal rig assembly of claim 1 wherein said enclosed couplings do not extend beyond either of said primary member assembly body first end or said primary member assembly body second end.

14. The animal rig assembly of claim 1 wherein said used device includes a number of units and wherein:
said attachment assembly includes a number of compartments on at least one of said primary member assembly body inner surface or outer surface; and
each said attachment assembly compartment sized to generally correspond to one said use device unit.

15. The animal rig assembly of claim 14 wherein each said primary member assembly body compartment includes a porous surface.

16. An animal rig assembly comprising:
a primary member assembly including an elongate body, said primary member body including an outer surface, an inner surface, a first end, a medial portion, and a second end;
an attachment assembly coupled to said primary member body;
said attachment assembly structured to position a use device on said primary member body inner surface;
said attachment assembly includes number of enclosed couplings;
said number of enclosed couplings includes a first enclosed coupling;
said first enclosed coupling structured to enclose a portion of said use device;
a number of use devices; and
each said use device is disposed at least partially within said first enclosed coupling.

17. The animal rig assembly of claim 16 wherein:
said number of enclosed couplings includes a plurality of enclosed couplings;
said number of use devices includes a plurality of use devices; and
wherein each use device is substantially disposed within an associated enclosed coupling.

18. The animal rig assembly of claim 16 wherein:
said first enclosed coupling is an end enclosure coupling; and
said first enclosed coupling is structured to be directly coupled to a use device unitary coupling.

19. The animal rig assembly of claim 1 wherein:
said primary member assembly includes a length adjustment device, said length adjustment device structured to alter the length of said primary member assembly body between a first length and a second length;
said number of enclosed couplings includes a second enclosed coupling;
wherein said first enclosed coupling is disposed adjacent said primary member assembly body first end when said primary member assembly body is at said first length and when said primary member assembly body is at said second length; and
wherein said second enclosed coupling is disposed adjacent said primary member assembly body second end when said primary member assembly body is at said first length and when said primary member assembly body is at said second length.

20. The animal rig assembly of claim 19 wherein:
each said use device includes an elongated body having a first end, a medial portion, and a second end;
said use device body first end including a unitary coupling;
said use device body second end including a unitary coupling;
wherein said first enclosed coupling is an end pocket; and
said second enclosed coupling is an end pocket.
